(19) United States
(12) Patent Application Publication
(10) Pub. No.: US 2002/0196776 A1
(43) Pub. Date: Dec. 26, 2002

(54) Communication system of automatically setting basic data of voice over IP devices

(76) Inventor: Hsiang-Yu Chiang, Hsinchu (TW)

Correspondence Address: BACON & THOMAS, PLLC, 625 SLATERS LANE, FOURTH FLOOR, ALEXANDRIA, VA, 22314

(21) Appl. No.: 09/888,424

(22) Filed: Jun. 26, 2001

(51) Int. Cl. H04L 12/66

(52) U.S. Cl. 370/352; 370/392

(57) ABSTRACT

A communication system of automatically setting basic data of VoIP devices in which every VoIP device sends the respective MAC address to the call agent subject to DHCP after connection of the VoIP devices to the Internet, requesting for the related setting data of the VoIP devices at the call agent so that the call agent searches the setting data of every VoIP device subject to DHCP upon receipt of the request from every VoIP device, and then automatically distributes the setting data to every VoIP device.

### BACKGROUND OF THE INVENTION

The present invention relates to an Internet communication system and, more particularly, to such an Internet communication system adapted to automatically set basic data of voice over IP device.

Internet phones have become more and more popularly accepted for the advantage of low payment for long distance call and international call. A variety of VoIP (Voice Over IP) devices have been disclosed for long distance call and international call through the Internet. According to investigations, more than 70% of conventional telephone users show interest in using a VoIP device to make a long distance or international call. This big amount of communication users and demand will cause VoIP device managers (for example, call agents) to face the following problems:

(1) How to recognize VoIP device users?

(2) How to assign IP address of VoIP?

(3) How to update or change call agent's set data without affecting the use of VoIP device?

(4) How to let user's VoIP device function go well without the action of correcting the settings manually?

(5) How to execute VoIP device software upgrading automatically?

Further, when using an existing VoIP device to make a network communication, it is necessary to run the setting and management of the following set values:

(1) Call agent's IP address or name of DNS and/or default port number: for enabling VoIP device to search call agent subject to IP address or name of DNS.

(2) IP address of DNS: VoIP device searches DNS subject to IP address, and uses call agent's name of DNS to convert to corresponding IP address.

(3) ID of VoIP device (for example, gateway domain name in MGCP endpoint identifier): VoIP device enables call agent to recognize user's identification by means of ID of VoIP device but not through VoIP device's IP address.

(4) Filename and TFTP (Trivial File Transfer Protocol) server's IP address of VoIP device: using these information, VoIP device judges if to upgrade edition of software.

VoIP devices achieve the setting or correction of the aforesaid set values subject to the following two methods:

(1) VoIP device provides a RS-232 port for the connection of computer's COM port by the call agent management person so that call agent management person can use computer's software (win98 terminal) to log in the picture of settings of VoIP device and to direct set or correct the settings. The main drawback of this method is that the call agent management person must directly go to the site of VoIP device to set or correct the settings. Because the call agent management person must directly go to the site of VoIP device to set or correct the settings, much labor and time are wasted.

(2) VoIP device provides a HTTP server (or TELNET server) for enabling the call agent management person to log in the picture of settings of VoIP device by means of a remote computer through an Internet browser (or TELNET), and then to make or correct the settings. The main drawback of this method is that the call agent management person must know the IP address of every VoIP device so that the picture of settings of the respective VoIP device can be accurately logged in. Further, according to this method, any two VoIP devices cannot have the same IP address.

When making or correcting the settings of VoIP devices through an Internet browser, call agent management person must search the IP address of a first VoIP device, then log in the picture of settings of the first VoIP device, and then make or correct the settings, and then leave from the first VoIP device, and then search the IP address of a second VoIP device, and then log in the picture of settings of the second VoIP device, and then make or correct the settings of the second VoIP device, and then leave from the second VoIP device. These procedures are repeated again and again until the settings of all VoIP devices have been well done. The call agent management person must repeat the setting action ten times if there are ten VoIP devices to be set, or one thousand times if there are one thousand VoIP devices to be set. Any further correction of settings is required, the aforesaid action of setting (the call agent side as well as the end-user side) must be repeated again. It is a hard task to run the action of setting in this way.

More particularly, when the number of VoIP device users is increased drastically, the task of controlling and maintaining a big number of VoIP devices is not easy. Therefore, it is desirable to provide an improved method of controlling and maintaining VoIP device settings automatically so as to save labor and time consumption in making or correcting the settings of VoIP devices, and to eliminate human error during the action of setting.

### SUMMARY OF THE INVENTION

The invention has been accomplished under the circumstances in view. According to one aspect of the present invention, every VoIP device sends the respective MAC address to the call agent subject to a communication protocol installed in every VoIP device after connection of the VoIP devices to the Internet, requesting for the related setting data of the VoIP devices at the call agent so that the call agent searches the setting data of every VoIP device subject to the communication protocol upon receipt of the request from every VoIP device, and then automatically distributes the setting data to every VoIP device.

According to another aspect of the present invention, the communication protocol can be DHCP (Dynamic Host Configuration Protocol) or BOOTP (Bootstrap Protocol).

According to still another aspect of the present invention, the setting data includes every VoIP device's TFTP filename and the TFTP server's IP address of every VoIP device such that when the edition of the driver software of the VoIP devices is upgraded, the upgraded edition of the driver software is installed in the TFTP server, and every VoIP device can determine if it is necessary to download the upgraded driver software when receiving the setting data from the call agent, and every VoIP device can directly download the upgraded driver software from the TFTP server subject to the respective IP address when required, and the VoIP device can judge if the assigned upgraded edition has existed in it or not when downloaded a first packet, preventing a repeat download of the same edition of driver software that gives a burden to the flow of the Internet.

According to still another aspect of the present invention, the setting data further includes the setting data that changes the function of the VoIP devices so that the VoIP device immediately download the assigned setting file and check the content of the assigned setting file upon receipt of the setting data from the call agent, and then correct the respective set values subject to the content of the assigned setting file.

### BRIEF DESCRIPTION OF THE DRAWINGS

FIG. 1 is a system block diagram of the communication system of the present invention.

### DETAILED DESCRIPTION OF THE PREFERRED EMBODIMENT

In Internet communication protocols, DHCP (Dynamic Host Configuration Protocol) enables the electronic device of an Internet user to transmit Ethernet Address to the electronic device of one server by means of broadcast packet through the Internet, so as to obtain from the electronic device of the server the related setting data, for example, IP address, netmask, default gateway, and DNS value. The end-user's electronic device using DHCP to make communication is hereinafter called as “DHCP end-user”, and the corresponding server's electronic device is hereinafter called as “DHCP server””. Upon receipt of a broadcast packet from a DHCP end-user, the DHCP server immediately searches the setting data of the DHCP end-user from its database, and then sends the searched setting data to the DHCP end-user.

Normally, the data stored in the DHCP server's database includes static data and dynamic data. The static data is the basic data of he IP address, netmask, default gateway and DNS value of the DHCP end-users being connected to the DHCP server. The dynamic data is the reserved IP addresses for being selected and distributed to the DHCP end-user when the DHCP server cannot search the Ethernet Address and the corresponding data from the static data subject to the request packet from the DHCP end-user.

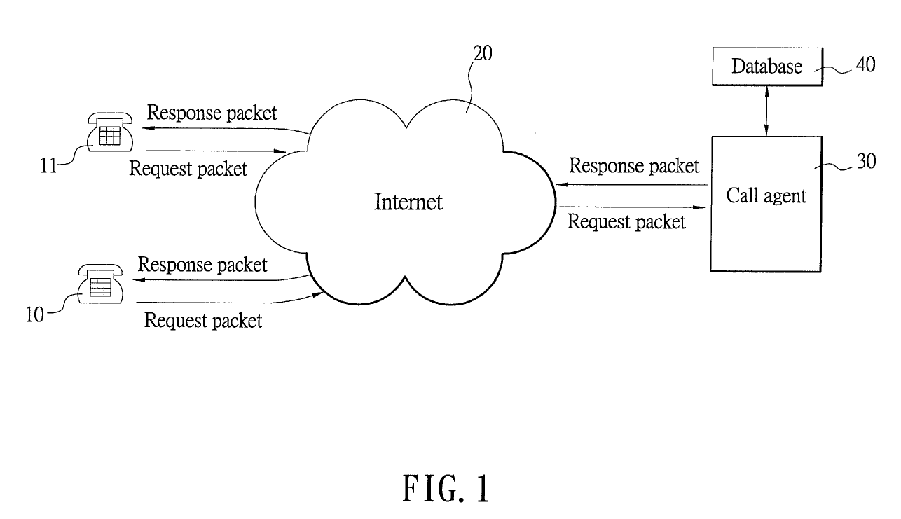

By means of utilizing the advantage of DHCP protocol of capable of automatically distributing an IP address to every DHCP end-user, the invention sets the VoIP device of every end-user as the DHCP end-user and the VoIP device basic data control device (hereinafter called as the call agent) as the DHCP server, as shown in FIG. 1. After every VoIP device 10;11 connects to the Internet 20, every VoIP device 10;11 can send its Ethernet Address to the call agent 30 by broadcast subject to DHCP protocol, to request for the related setting data at the call agent 30. Subject to this request, the call agent 30 searches the setting data of the respective VoIP device from its database 40, and automatically distributes a respective IP address to every VoIP device 10;11. The related information is provided when sending the respective IP address to every VoIP device. Because the management of the setting control of all VoIP devices is handled at the call agent and the call agent can automatically distribute the respective IP address and other setting data to every VoIP device subject to DHCP and the request of every VoIP device, every VoIP device can automatically obtain from the call agent the respective basic setting values without through a manual control by a call agent management person.

Because every VoIP device has a unique MAC address, the call agent can use the MAC address of every VoIP device as its unique Ethernet Address after the installation of DHCP, and therefore every VoIP is individually identified. When all VoIP devices are connected to the Internet, the driver software of every VoIP device can actively send its MAC address to the call agent subject to DHCP, to request for providing the related setting data. When searched, the call agent automatically sends the related setting data to the respective VoIP device. The basic setting data of the VoIP devices include:

(1) The respective VoIP device's IP address and/or subnet mask, IP of default router;

(2) The respective VoIP device's ID (for example, gateway domain name in MGCP endpoint identifier . . . );

(3) The call agent's IP address, internal connection serial number or DNS name (including local name, domain name);

(4) DNS server's IP address.

According to the present invention, the setting data further includes every VoIP device's TFTP filename and TFTP server's IP address. If the edition of the driver software of the VoIP devices is upgraded, the upgraded edition of the driver software is installed in the TFTP server, so that every VoIP device can determine if it is necessary to download the upgraded driver software when receiving the setting data from the call agent. Subject to the respective IP address, every VolP device can directly download the upgraded driver software from the TFTP server. When downloaded a first packet, the VoIP device judges if the assigned upgraded edition has existed in it or not, preventing a repeat download of the same edition of driver software that gives a burden to the flow of the Internet. According to this method, the call agent management person needs not to delete the upgraded information (TFTP filename and TFTP server's IP address after the VoIP devices have completed the upgrading action), and the VoIP devices will never repeatedly download the TFTP file.

Further, the setting data may include the setting data that changes the function of the VoIP devices. Upon receipt of the setting data from the call agent, the VoIP devices immediately download the assigned setting file and check the content of the assigned setting file, and then correct the respective set values subject to the content of the assigned setting file, for example, starting DNS, DTMF relay, NAT, or DHCP server; correcting the frequency value of Transmit Gain or Receive Gain value; correcting Dial tone, Ring Back Tone, or Busy Tone, . . . etc.

In an alternate embodiment of the present invention, BOOTP (Bootstrap Protocol) is used. Because BOOTP has the aforesaid DHCP features and similar packet format, the invention utilizes the characteristic of FOOTP of automatically distributing an IP address to every BOOTP end-user to set every user's VoIP device as a BOOTP end-user and the call agent as the BOOTP server, such that every VoIP device can send the respective MAC address to the call agent subject to BOOTP, to request for the related setting data at the call agent, and the call agent can search the respective setting data from its database and automatically distribute the respective IP address and the related information to every VoIP device upon receipt of the request.

Thus, the VOIP devices can automatically obtain the basic setting values, and management person is free from correcting the setting of every VoIP device individually. Therefore, the invention saves much labor and time in correcting the settings of every VOIP device, provides every VoIP device with the function of plug and play, and prevents line busy due to matching problem between the end-user and the call agent during normal function of the network.

A prototype of Internet communication system has been constructed with the features of FIG. 1. The Internet communication system functions smoothly to provide all of the features discussed earlier.

Although particular embodiments of the invention have been described in detail for purposes of illustration, various modifications and enhancements may be made without departing from the spirit and scope of the invention. Accordingly, the invention is not to be limited except as by the appended claims.

What the invention claimed is:

1. A communication system of automatically setting basic data of VoIP devices that sends the MAC address of an VoIP (Voice Over IP) device to a call agent subject to a communication protocol installed in said VoIP device after connection of the VoIP device to the Internet, requesting for the related setting data of the VoIP device at the call agent so that the call agent searches the setting data of the VoIP device subject to said communication protocol upon receipt of the request from said VoIP device, and then automatically distributes the setting data to said VoIP device.

2.The communication system of automatically setting basic data of VoIP devices of claim 1 wherein said setting data includes:
said VoIP device's IP address;
said VoIP device's identifier;
said call agent's IP address; and
the IP address of the DNS server of said call agent.

3. The communication system of automatically setting basic data of VoIP devices of claim 2 wherein said setting data further includes said VoIP device's TFTP filename and the TFTP server's IP address of said VoIP device such that when the edition of the driver software of said VoIP device is upgraded, the upgraded edition of the driver software is installed in the TFTP server, and said VoIP device can determine if it is necessary to download the upgraded driver software when receiving the setting data from the call agent, and said VoIP device can directly download the upgraded driver software from the TFTP server subject to the respective IP address when required, and said VoIP device can judge if the assigned upgraded edition has existed in it or not when downloaded a first packet, preventing a repeat download of the same edition of driver software that gives a burden to the flow of the Internet.

4. The communication system of automatically setting basic data of VoIP devices of claim 3 wherein said setting data further includes the setting data that changes the function of said VoIP device so that said VoIP device immediately downloads the assigned setting file and checks the content of the assigned setting file upon receipt of the setting data from said call agent, and then corrects the respective set values subject to the content of the assigned setting file.

5. The communication system of automatically setting basic data of VoIP devices of claim 1, wherein said communication protocol is DHCP (Dynamic Host Configuration Protocol).

6. The communication system of automatically setting basic data of VoIP devices of claim 1, wherein said communication protocol is BOOTP (Bootstrap Protocol).
